(19) United States
(12) Patent Application Publication
(10) Pub. No.: US 2022/0215561 A1
(43) Pub. Date: Jul. 7, 2022

(54) SEMANTIC-ASSISTED MULTI-RESOLUTION POINT CLOUD REGISTRATION

(71) Applicant: BEIJING DIDI INFINITY TECHNOLOGY AND DEVELOPMENT CO., LTD., Beijing (CN)

(72) Inventor: Xiaoling ZHU, Beijing (CN)

(73) Assignee: BEIJING DIDI INFINITY TECHNOLOGY AND DEVELOPMENT CO., LTD., Beijing (CN)

(21) Appl. No.: 17/701,496

(22) Filed: Mar. 22, 2022

Related U.S. Application Data
(63) Continuation of application No. PCT/CN2019/107538, filed on Sep. 24, 2019.

(51) Int. Cl. G06T 7/30; G06T 7/10; G06T 7/70

(52) U.S. Cl. CPC G06T 7/30; G06T 2207/10028; G06T 7/70; G06T 7/10

(57) ABSTRACT

Systems and methods for registering point clouds are provided. An exemplary method includes parsing semantic information from source and target point clouds, segmenting points in the source point cloud into first and second groups based on the semantic information, segmenting points in the target point cloud into third and fourth groups based on the semantic information, determining an initial pose of the source point cloud by registering the first group of points in the source point cloud to the third group of points in the target point cloud according to a first resolution, and adjusting the initial pose of the source point cloud by registering the second group of points in the source point cloud to the fourth group of points in the target point cloud according to a second resolution, wherein the second resolution is different from the first resolution.

### CROSS-REFERENCE TO RELATED APPLICATIONS

This application is a bypass continuation to PCT Application No. PCT/CN2019/107538, filed Sep. 24, 2019, the content of which is hereby incorporated by reference in its entirety.

### TECHNICAL FIELD

The present application relates to autonomous driving and high-resolution map creation. More specifically, the present application relates to systems and methods for registering point clouds based on semantic information and multi-resolution segmentation in autonomous driving and/or creating high-resolution maps.

### BACKGROUND

Point cloud registration is an important process in applications such as high-resolution map creation and autonomous driving. In a typical point cloud registration process, a source point cloud is registered to a target point cloud such that the two point clouds align or match to each other. Current methods register point clouds in an iterative process, in which the pose (e.g., position and orientation) of the source point cloud is iteratively changed to an optimal value (e.g., toward the pose of the target point cloud), starting from an initial estimation. However, existing methods are sensitive to the accuracy of the initial estimation. If the initial estimation is not sufficiently accurate, then the iteration process may converge to a local optimum, failing to reach the global optimal solution. In addition, some existing methods require division of the point cloud space into a grid of cells, and the performance of the registration relies on the size of the cells (also referred to as resolution). If the resolution is too low (cells are too big), the performance of the registration is poor. On the other hand, if the resolution is too high, the computational cost is also high, leading to low efficiency. The problem of balancing the performance, efficiency, and the choice of resolution remains untackled. Moreover, existing methods perform the registration process over the entire set of points in the point clouds without distinguishing the differences among different kinds of objects, often resulting in unsatisfactory results.

Embodiments in the present disclosure address the aforementioned problems by providing systems and methods for registering point clouds based on semantic information and multi-resolution segmentation.

### SUMMARY

In one aspect, a system for registering point clouds is provided. The system may include a memory storing computer-executable instructions and at least one processor communicatively coupled to the memory. The computer-executable instructions, when executed by the processor, may cause the processor to perform operations. The operations may include parsing semantic information from a source point cloud and a target point cloud. The operations may also include segmenting points in the source point cloud into first and second groups based on the semantic information parsed from the source point cloud. The operations may also include segmenting points in the target point cloud into third and fourth groups based on the semantic information parsed from the target point cloud. The operations may further include determining an initial pose of the source point cloud by registering the first group of points in the source point cloud to the third group of points in the target point cloud according to a first resolution. In addition, the operations may include adjusting the initial pose of the source point cloud by registering the second group of points in the source point cloud to the fourth group of points in the target point cloud according to a second resolution. The second resolution may be different from the first resolution.

In another aspect, a method for registering point clouds is provided. The method may include parsing semantic information from a source point cloud and a target point cloud. The method may also include segmenting points in the source point cloud into first and second groups based on the semantic information parsed from the source point cloud. The method may also include segmenting points in the target point cloud into third and fourth groups based on the semantic information parsed from the target point cloud. The method may further include determining an initial pose of the source point cloud by registering the first group of points in the source point cloud to the third group of points in the target point cloud according to a first resolution. In addition, the method may include adjusting the initial pose of the source point cloud by registering the second group of points in the source point cloud to the fourth group of points in the target point cloud according to a second resolution. The second resolution may be different from the first resolution.

In a further aspect, a non-transitory computer-readable medium storing instructions is provided. The instructions, when executed by at least one processor, may cause the processor to perform a method for registering point clouds. The method may include parsing semantic information from a source point cloud and a target point cloud. The method may also include segmenting points in the source point cloud into first and second groups based on the semantic information parsed from the source point cloud. The method may also include segmenting points in the target point cloud into third and fourth groups based on the semantic information parsed from the target point cloud. The method may further include determining an initial pose of the source point cloud by registering the first group of points in the source point cloud to the third group of points in the target point cloud according to a first resolution. In addition, the method may include adjusting the initial pose of the source point cloud by registering the second group of points in the source point cloud to the fourth group of points in the target point cloud according to a second resolution. The second resolution may be different from the first resolution.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR device, according to embodiments of the disclosure.

FIG. 2 illustrates a block diagram of an exemplary system for registering point clouds, according to embodiments of the disclosure.

FIG. 3 illustrates an exemplary application in which point cloud registration is performed using embodiments of the disclosure.

FIGS. 4-8 illustrate flow charts of exemplary methods for registering point clouds, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Light detection and ranging (LiDAR) devices have been widely used in applications such as high-resolution map creation and vehicle self-localization in autonomous driving. For example, a LiDAR device may be equipped on a survey vehicle to collect three-dimensional (3D) data of roads as well as surrounding environment as the survey vehicle is travelling along a trajectory. The collected 3D data may be in the form of point clouds, e.g., a set of points indicating the spatial locations on object surfaces that reflect laser beams emitted by the LiDAR device. Because the range of a LiDAR device is finite, a point cloud resulting from a LiDAR scan may include points within a limited space surrounding the survey vehicle. As the survey vehicle travels along a road, the LiDAR device may perform multiple scans, generating multiple point clouds, which may be combined to create a larger point cloud. A combined point cloud over an extended area may serve as an important part of a high-resolution map. Combining multiple point clouds often involves matching or aligning one point cloud to another (e.g., adjacent) point cloud, a process often referred to as point cloud registration.

In autonomous driving applications, a self-driving vehicle may sense the road conditions and surrounding environment using a LiDAR device, which may generate 3D information in the form of a point cloud (e.g., a source point cloud). The point cloud may be compared with a reference point cloud (e.g., a target point cloud) in a high-resolution map to determine the pose (e.g., position and orientation) of the self-driving vehicle, thereby providing, for example, high-precision self-localization information to aid self-driving decision making. The comparison may include matching or aligning the point cloud obtained by the LiDAR device (e.g., the source point cloud) to the corresponding reference point cloud (e.g., the target point cloud) in the high-resolution map, which is also a point cloud registration process.

Current point cloud registration methods such as iterative closest point (ICP) and normal-distributions transform (NDT) use an iterative approach, which starts from an initial pose estimation and iteratively change the pose toward an optimized direction. However, existing methods are sensitive to the initial pose estimation and susceptible to the errors in the initial pose estimation. For example, when the initial pose estimation is not sufficiently accurate, the iteration process may be trapped at a local optimal solution, failing to reach the global optimal solution. Moreover, in NDT, in order to compute the normal distributions, the point cloud space are divided into a grid of cells. The size of the cells, referred to as the spatial resolution or simply resolution, has significant impact on the performance of the registration. If the resolution is too low (cells are too big), the precision of the registration is poor, leading to low performance. On the other hand, if the resolution is too high, the computational cost is also high, leading to low efficiency. The problem of balancing the performance, efficiency, and the choice of resolution remains untackled. Further, existing methods perform the registration process over the entire set of points in the point clouds without distinguishing the differences among different kinds of objects, often resulting in unsatisfactory results.

Embodiments of the present disclosure provide improved systems and methods for registering point clouds, utilizing semantic information contained in the point clouds to adaptively choose the resolution of the spatial grid. For example, embodiments of the present disclosure can parse the semantic information from source and target point clouds by classifying points into categories using a trained classifier and associating semantic labels with points in the categories. Based on the semantic information, points in the point clouds can be segmented into different groups (e.g., based on common properties such as size, shape, curvature, etc.). Then, a lower resolution is used to generate a relatively coarse spatial grid to determine an initial pose of the source point cloud by registering one group of segmented points in the source point cloud to the corresponding group of points in the target point cloud. The initial pose can be refined and/or adjusted by applying a higher resolution (e.g., relatively dense) spatial grid to register another group of segmented points in the source point cloud to the corresponding group of segmented points in the target point cloud. In this way, the initial pose can be obtained more efficiently than conventional methods because a relatively coarse spatial grid with a relatively low resolution is used to register a subset of points (e.g., corresponding to objects having larger size or less details) segmented based on semantic information. Highly precise and/or accurate registration can be obtained by refining/adjusting the initial pose using a relatively dense spatial grid with a relatively high resolution to register another subset of points (e.g., corresponding to objects having smaller size or finer details). Embodiments of the present disclosure can also improve the robustness of point cloud registration because the initial pose determination using low resolution spatial grid is less sensitive and suspectable to estimation errors and less likely to cause the iteration process to be trapped in local optima compared to conventional methods.

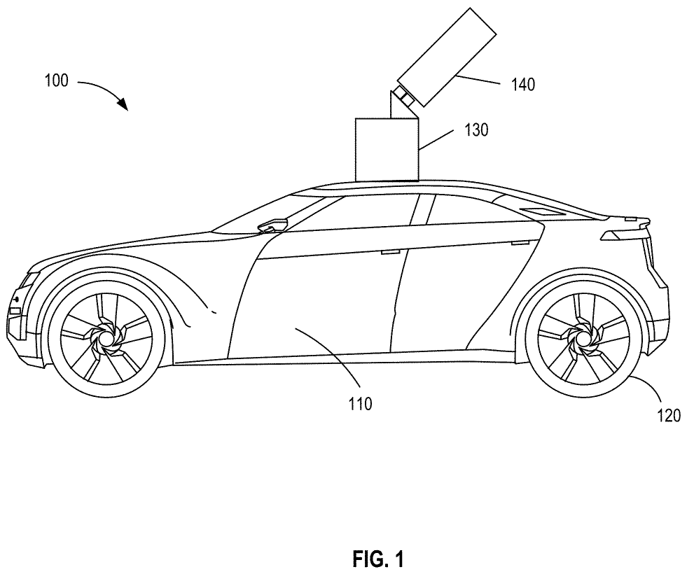

Embodiments of the present disclosure may be implemented using hardware, software, firmware, or any combination thereof. Components of the embodiments can reside in a cloud computing environment, one or more servers, one or more terminal devices, or any combination thereof. In some cases, at least part of the point cloud registration system disclosed herein may be integrated with or equipped as an add-on device to a vehicle. For example, FIG. 1 illustrates a schematic diagram of an exemplary vehicle 100 that may include one or more components of a point registration system, according to embodiments of the present disclosure. As shown in FIG. 1, vehicle 100 may be equipped with a LiDAR device 140. In some embodiments, vehicle 100 may be a survey vehicle configured to acquire data using LiDAR device 140 for constructing a high-resolution map or three-dimensional (3-D) city model. In some embodiments, vehicle 100 may be an autonomous driving vehicle using LiDAR device 140 to sense surrounding environment, road conditions, traffic conditions, pedestrian presence, or other information related to autonomous driving and/or navigation. It is contemplated that vehicle 100 may be an electric vehicle, a fuel cell vehicle, a hybrid vehicle, or a conventional internal combustion engine vehicle. Vehicle 100 may have a body 110 and at least one wheel 120. Body 110 may be of any body style, such as a sports vehicle, a coupe, a sedan, a pick-up truck, a station wagon, a sports utility vehicle (SUV), a minivan, or a conversion van. In some embodiments, vehicle 100 may include a pair of front wheels and a pair of rear wheels, as illustrated in FIG. 1. However, it is contemplated that vehicle 100 may have less wheels or equivalent structures that enable vehicle 100 to move around. Vehicle 100 may be configured to be all wheel drive (AWD), front wheel drive (FWR), or rear wheel drive (RWD). In some embodiments, vehicle 100 may be configured to be operated by an operator occupying the vehicle, remotely controlled, and/or autonomous.

As illustrated in FIG. 1, vehicle 100 may be equipped with LiDAR device 140 mounted to body 110 via a mounting structure 130. Mounting structure 130 may be an electro-mechanical device installed or otherwise attached to body 110 of vehicle 100. In some embodiments, mounting structure 130 may use screws, adhesives, or another mounting mechanism. It is contemplated that the manners in which LiDAR device 140 can be equipped on vehicle 100 are not limited by the example shown in FIG. 1. The equipping manners may be modified depending on the type of LiDAR device 140 and/or vehicle 100 to achieve desirable sensing/scanning performance.

In some embodiments, LiDAR device 140 may be configured to capture data as vehicle 100 moves along a trajectory. For example, LiDAR device 140 may be configured to scan the surrounding and acquire point clouds. LiDAR measures distance to a target object by illuminating the target object with pulsed laser beams and measuring the reflected pulses with a photodetector. Differences in laser return times, phases, or wavelengths can then be used to calculate distance information (also referred to as “range information”) and construct digital 3-D representations of the target object (e.g., a point cloud). The laser light used for LiDAR scan may be ultraviolet, visible, or near infrared. As vehicle 100 moves along the trajectory, LiDAR device 140 may acquire a series of point clouds at multiple time points, which may be used to construct a high definition map or facilitate autonomous driving.

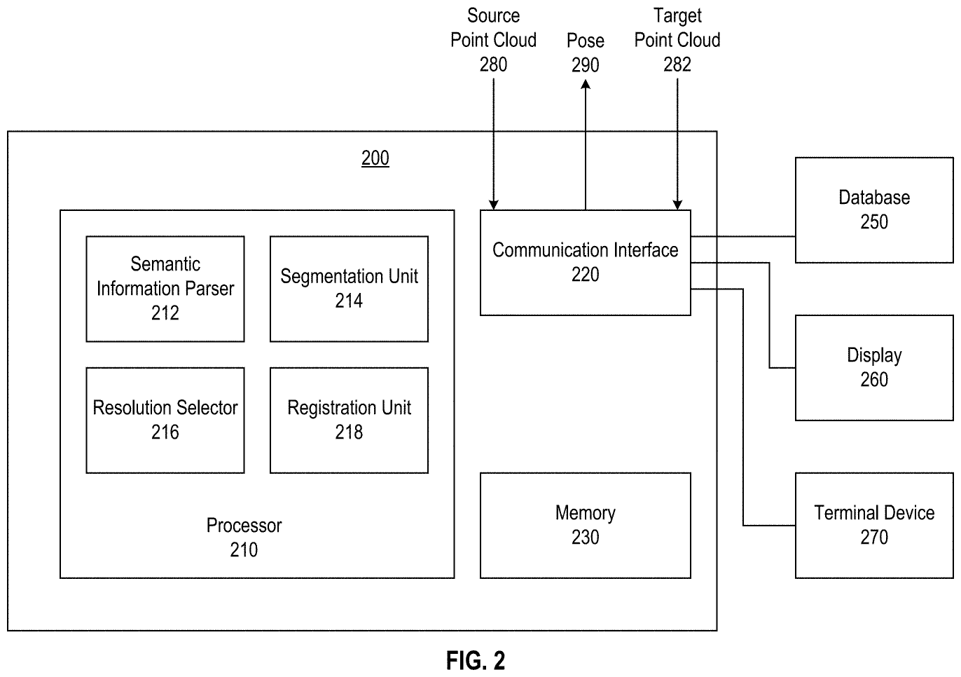

FIG. 2 illustrates a block diagram of an exemplary system 200 for registering point clouds. As shown in FIG. 2, system 200 may include a processor 210, a communication interface 220, and a memory 230. It is contemplated that system 200 may also include other components or devices to facilitate point cloud registration.

Memory 230 may be configured to store computer-executable instructions that, when executed by at least one processor (e.g., processor 210), can cause the at least one processor to perform various operations disclosed herein. Memory 230 may be any non-transitory type of mass storage, such as volatile or non-volatile, magnetic, semiconductor-based, tape-based, optical, removable, non-removable, or other type of storage device or tangible computer-readable medium including, but not limited to, a ROM, a flash memory, a dynamic RAM, and a static RAM.

Processor 210 may be configured to perform the operations in accordance with the computer-executable instructions stored on memory 230. Processor 210 may include any appropriate type of general-purpose or special-purpose microprocessor, digital signal processor, microcontroller, or the like. Processor 210 may be configured as a separate processor module dedicated to performing one or more specific operations. Alternatively, processor 210 may be configured as a shared processor module for performing other operations unrelated to the one or more specific operations disclosed herein. As shown in FIG. 2, processor 210 may include multiple modules/units, such as a semantic information parser 212, a segmentation unit 214, a resolution selector 216, a registration unit 218, and the like. These modules/units (and any corresponding sub-modules or sub-units) can be hardware units (e.g., portions of an integrated circuit) of processor 210 designed for use with other components or implemented by executing part of a program or software codes stored on memory 230. Although FIG. 2 shows modules 212-218 all within one processor 210, it is contemplated that these modules may be distributed among multiple processors located closely or remotely with each other.

Communication interface 220 may be configured to communicate information between system 200 and other devices or systems. For example, communication interface 220 may include an integrated services digital network (ISDN) card, a cable modem, a satellite modem, or a modem to provide a data communication connection. As another example, communication interface 220 may include a local area network (LAN) card to provide a data communication connection to a compatible LAN. As a further example, communication interface 220 may include a high-speed network adapter such as a fiber optic network adaptor, 10G Ethernet adaptor, or the like. Wireless links can also be implemented by communication interface 220. In such an implementation, communication interface 220 can send and receive electrical, electromagnetic or optical signals that carry digital data streams representing various types of information via a network. The network can typically include a cellular communication network, a Wireless Local Area Network (WLAN), a Wide Area Network (WAN), or the like

In some embodiments, communication interface 220 may communicate with a database 250 to exchange information related to point cloud registration. Database 250 may include any appropriate type of database, such as a computer system installed with a database management software. Database 250 may store high-resolution map data, target point cloud data, source point cloud data generated by LiDAR device 140, pose information generated by system 200, training data sets, or any data related to point cloud registration.

In some embodiments, communication interface 220 may communicate with an output device, such as a display 260. Display 260 may include a display device such as a Liquid Crystal Display (LCD), a Light Emitting Diode Display (LED), a plasma display, or any other type of display, and provide a Graphical User Interface (GUI) presented on the display for user input and data depiction. For example, pose information, source and/or target point cloud image rendering, a high-resolution map, a navigation interface, or any other information related to point cloud registration may be displayed on display 260.

In some embodiments, communication interface 220 may communicate with a terminal device 270. Terminal device 270 may include any suitable device that can interact with a user and/or vehicle 100. For example, terminal device 270 may include LiDAR device 140, a desktop computer, a laptop computer, a smart phone, a tablet, a wearable device, a vehicle on-board computer, an autonomous driving computer, or any kind of device having computational capability sufficient to support collecting, processing, or storing point cloud data, pose information, autonomous driving information, or the like.

Regardless of which devices or systems are communicatively coupled to system 200 through communication interface 220, communication interface 220 may receive a source point cloud 280 and a target point cloud 282, and generate a pose 290 associated with source point cloud 280 such that applying pose 290 to source point cloud 280 would register source point cloud 280 to target point cloud 282. Pose 290 may include various types of information. For example, pose 290 may include linear spatial transformation or shifting, rotation along any suitable axis, panning, tilting, pitching, yawing, rolling, or any other suitable manner of spatial movement.

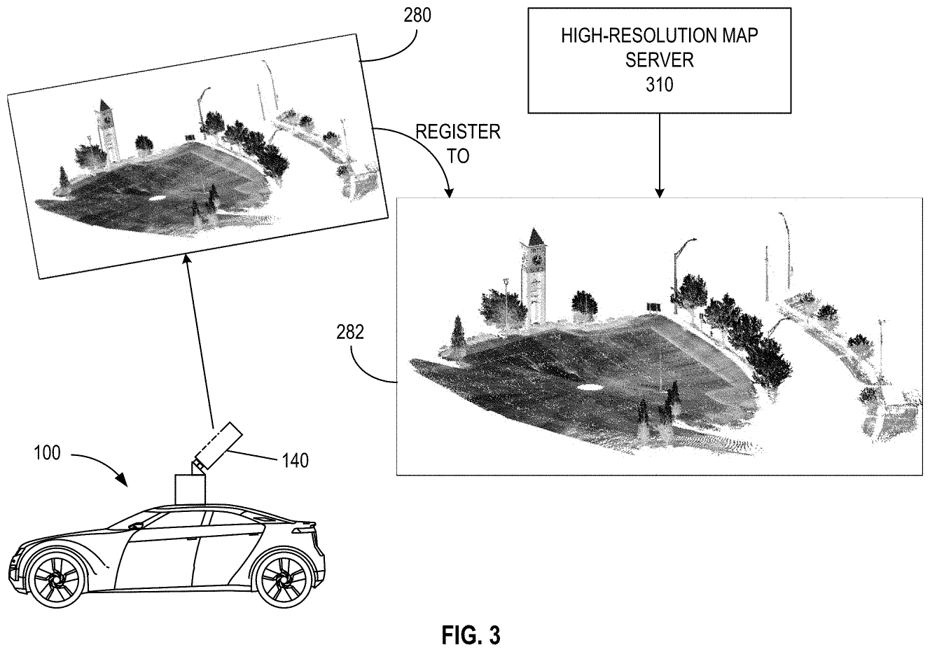

FIG. 3 illustrates an exemplary application in which point cloud registration is performed using system 200. Referring to FIG. 3, vehicle 100 may be a self-driving vehicle performing autonomous driving and using LiDAR device 140 to scan the surrounding environment and generate source point cloud 280. Consistent with the disclosed embodiments, processor 210 may be configured to receive source point cloud 280 from LiDAR device 140 (e.g., one type of terminal device 270) through communication interface 220. Processor 210 may then register source point cloud 280 to target point cloud 282 received from a high-resolution map server 310 (e.g., one type of database 250). Target point cloud 282 may be part of a high-resolution map at or around the location of vehicle 100. For example, a geographical positioning signal (e.g., a GPS signal) may be used to indicate the geolocation of vehicle 100, based on which target point cloud 282 at or around the geolocation may be extracted and sent to system 200.

In some embodiments, processor 210 may be configured to receive source point cloud 280 from database 250. For example, database 250 may store multiple point clouds obtained by a survey vehicle (e.g., vehicle 100). The multiple point clouds may contain partially overlapping portions (e.g., adjacent point clouds obtained from consecutive scans using LiDAR device 140). These partially overlapping point clouds may be combined to creating a high-resolution map. System 200 may be used to register one point cloud (used as a source point cloud) to another overlapping point cloud (used as a target point cloud) such that the two point clouds align with each other and the overlapping portions match with each other. In this way, multiple point clouds can be combined and connected to form a larger point cloud covering an extended area, based on which a high-resolution map may be created. In some embodiments, combining multiple point clouds may be performed by system 200 onboard vehicle 100, such that multiple point clouds can be combined on-the-fly as new point cloud data are collected by LiDAR device 140. In this case, system 200 may receive source and target point cloud data from LiDAR device 140 instead of or in addition to database 250.

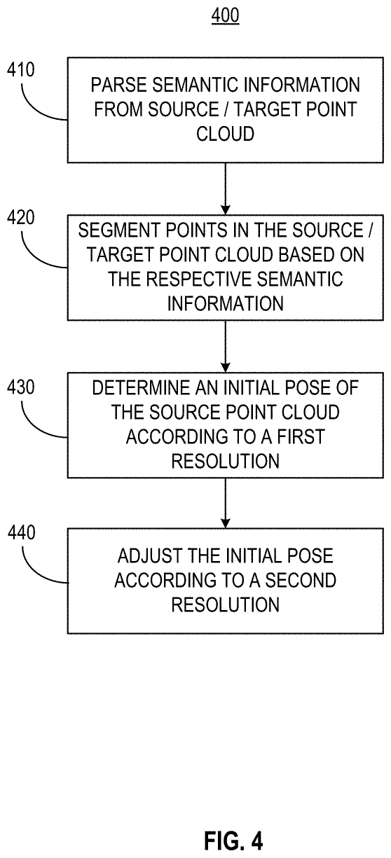

After receiving source point cloud 280 and target point cloud 282, processor 210 may, using one or more modules such as 212-218, register source point cloud 280 to target point cloud 282 to generate pose 290, which may be stored in memory 230 and/or sent to other devices/systems such as database 250, display 260, and terminal device 270. An exemplary work flow of registering source point cloud 280 to target point cloud 282 is illustrated in FIGS. 4-8. In the following, modules 212-218 of processor 210 will be described in connection with the work flow shown in FIGS. 4-8.

FIG. 4 illustrates a flowchart of an exemplary method 400 for registering point clouds, according to embodiments of the disclosure. In some embodiments, method 400 may be implemented by system 200 that includes, among other things, memory 220 and processor 210 that performs various operations using one or more modules 212-218. It is to be appreciated that some of the steps may be optional to perform the disclosure provided herein, and that some steps may be inserted in the flowchart of method 400 that are consistent with other embodiments according to the current disclosure. Further, some of the steps may be performed simultaneously, or in an order different from that shown in FIG. 4.

In step 410, semantic information parser 212 may parse semantic information from source point cloud 280 and/or target point cloud 282. For example, point clouds 280/282 may include surface points on a variety of objects. Semantic information may be parsed from the types, kinds, and/or categories of the underlying objects on which the points lie. In some embodiments, semantic information may include category information of the objects, for example, cars, trucks, pedestrians, buildings, plants, road signs, street lights, traffic lights, etc. In some embodiments, semantic information may include the size, shape, and/or curvature of the objects, for example, straight lines, curved lines, plane surfaces, curvatures, large objects, small objects, etc. In some embodiments, semantic information may include movement information of the objects, for example, stationary objects, moving objects, etc. It is contemplated that semantic information is not limited to the above-mentioned examples. Rather, semantic information may include any cognizable information that may distinguish one kind of objects from another kind of objects.

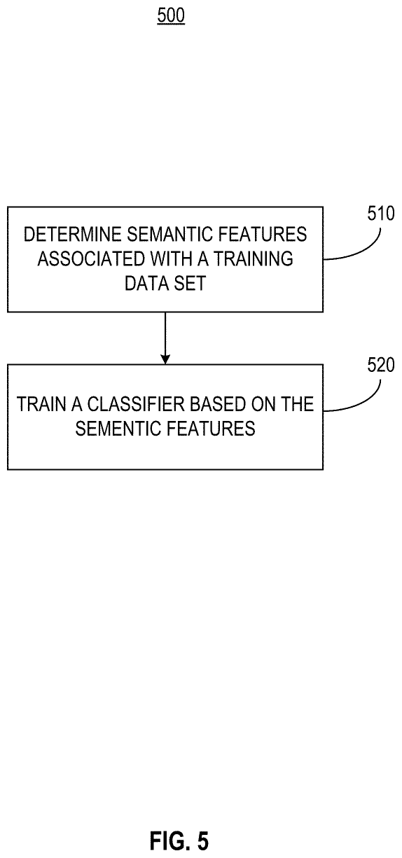

In some embodiments, semantic information parser 212 may parse semantic information using a classifier. The classifier may be based on a learning model and may be trained with a training data set. FIG. 5 illustrates a flow chat of an exemplary method 500 of training the classifier. Referring to FIG. 5, a training processor (may or may not be the same processor as processor 210) may determine semantic features associated with the training data set in step 510. The training data set may include point cloud data with known semantic information. For example, the training data set may include semantic labels associated with points in the point cloud data. The semantic labels may be applied based on observations of the point cloud data based on ground truth. In some embodiments, the known semantic information may be determined by comparing the point cloud data in the training data set with another set of data with known properties, such as photos, videos, maps, survey information, etc. The known semantic information such as semantic labels may be associated with points in the training data set manually or using computer-assisted semi-automatic processes.

In step 510, the training processor may use a deep neural network such as PointNet to compute the semantic features. The semantic features may be in any computer-readable form, such as a collection of points, lines, surfaces, shapes, with various levels of details, as known in the field of neural network. Base on the semantic features, the training processor may, in step 520, train the classifier to classify points into semantic categories, for example, associating semantic features with semantic labels. In some embodiments, the classifier may be in the form of a neural network, such as a PointNet-based neural network with trained parameters based on the training data set.

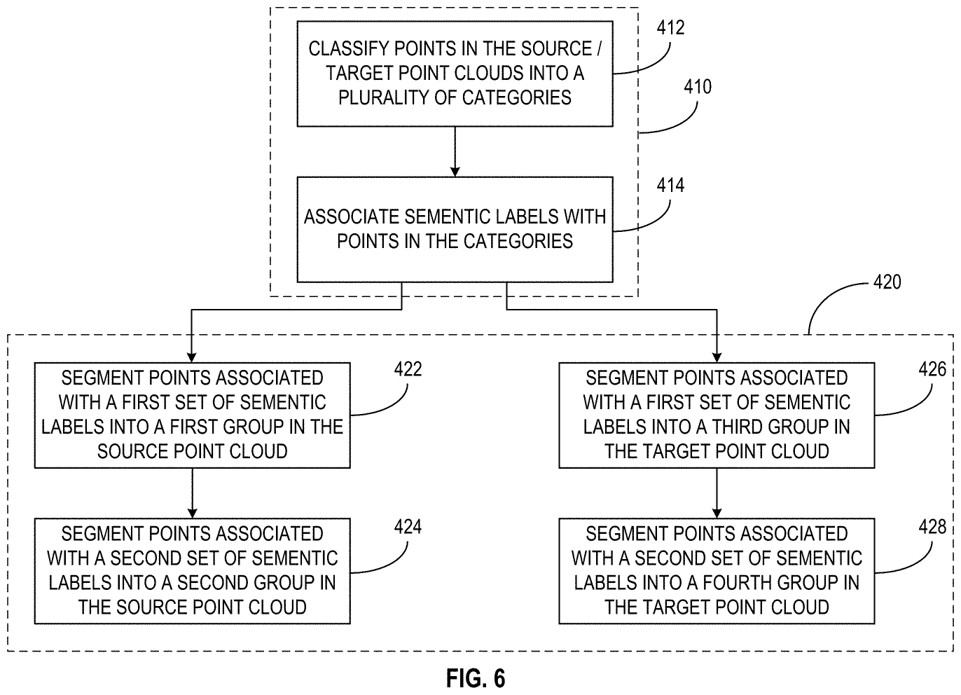

After the classifier is trained, semantic information parser 212 may use the classifier to classify the points in the source and target point clouds. FIG. 6 illustrates, in part, exemplary sub-steps of step 410. As shown in FIG. 6, in sub-step 412, semantic information parser 212 may classify, using the trained classifier, the points in the source and target point clouds into a plurality of categories. The categories may be based on the known semantic categories in the training data set. For example, the classifier may compute the semantic features of points in the source and target point clouds, and classify the points into categories based on the trained model (e.g., parameters). In sub-step 414, semantic information parser 212 may associate semantic labels with points in the categories. For example, semantic information parser 212 may associate a semantic label indicating a car with a set of points categorized as cars. In another example, semantic information parser 212 may associate a semantic label indicating a building with a set of points categorized as buildings.

It is contemplated that semantic labels and categories may or may not be the same. In some embodiments, associating semantic labels may be the same process as classifying points into categories. In such cases, sub-steps 412 and 414 may be combined into a single step. In some embodiments, associating semantic labels and classifying points into categories may be different processes. In such cases, sub-steps 412 and 414 may be separate steps.

In some embodiments, semantic information parser 212 may divide the source/target point clouds (280/282) into point blocks, each corresponding to a category or semantic label. In some embodiments, semantic information parser 212 may traverse each point in the source/target point clouds (280/282), and apply a category or semantic label to each point. In any case, after the points in the source and target point clouds (280 and 282) are categorized, classified, and/or associated with semantic labels, the semantic information parsing step 410 may finish.

Referring back to FIG. 4, in step 420, segmentation unit 214 may segment points in source point cloud 280 and/or target point cloud 282 based on the respective semantic information. For example, segmentation unit 214 may segment points in source/target point cloud 280/282 into groups based on the parsed semantic information. In some embodiments, segmentation unit 214 may segmenting points in source point cloud 280 into first and second groups based on the semantic information parsed from source point cloud 280, and segmenting points in target point cloud 282 into third and fourth groups based on the semantic information parsed from target point cloud 282. The first and third groups may correspond to each other, and the second and fourth groups may correspond to each other. For example, points in the first group may correspond to those points in source point cloud 280 that are on the surfaces of relatively large objects, while points in the second group may correspond to those points in source point cloud 280 that are on the surfaces of relatively small objects. Similarly, points in the third group may correspond to those points in target point cloud 282 that are on the surfaces of relatively large objects, while points in the fourth group may correspond to those points in target point cloud 282 that are on the surfaces of relatively small objects. The criteria for segmenting points into different groups may be based on the size, shape, curvature, reflectivity, color, or other properties of the objects. Such properties may be deduced for determined based on the semantic information parsed by semantic information parser 212. For example, buildings, plants, cars, trucks, etc. may form a “large-size” group (e.g., denoted as C_large), while pedestrians, artificial objects such as traffic lights, road signs, street marks, etc. may form a “small-size” group (e.g., denoted as C_small). Similarly, other types of groups may be used based on the semantic information, such as a “simple-shape” group (e.g., including objects having relatively simple shapes such as square, rectangle, triangle, etc.) verses a “complex-shape” group (e.g., including objects having relatively complex shapes); a “straight-line” group verse a “curved-line”group; a reflective group (e.g., including objects having reflective surfaces) versus a non-reflective group; etc.

FIG. 6 illustrates, in part, sub-steps 422-428 of step 420 to segment points in source/target point clouds 280/282 into groups. Referring to FIG. 6, sub-steps 422 and 424 may form a first branch with respective to source point cloud 280, while sub-steps 426 and 428 may form a second branch with respective to target point cloud 282. The first and second branches may be performed in any sequential order or in parallel.

In step 422, segmentation unit 214 may segment points associated with a first set of semantic labels into the first group in source point cloud 280. For example, the first set of semantic labels may correspond to objects having a first range of dimensions, such as buildings, plants, cars, trucks. Segmentation unit 214 may segment points in source point cloud 280 associated with the first set of semantic labels into a “large-size” group in source point cloud 280 (e.g., denoted as C_large_src). Similarly, in step 426, segmentation unit 214 may segment points associated with the first set of semantic labels into the third group in target point cloud 282. For example, segmentation unit 214 may segment points in target point cloud 282 associated with buildings, plants, cars, trucks, or similar semantic labels into a “large-size” group in target point cloud 282 (e.g., denoted as C_large_tgt).

In step 424, segmentation unit 214 may segment points associated with a second set of semantic labels into the second group in source point cloud 280. For example, the second set of semantic labels may correspond to objects having a second range of dimensions that are smaller than the objects having the first range of dimensions, such as pedestrians, artificial objects such as traffic lights, road signs, street marks, etc. Segmentation unit 214 may segment points in source point cloud 280 associated with the second set of semantic labels into a “small-size” group in source point cloud 280 (e.g., denoted as C_small_src). Similarly, in step 428, segmentation unit 214 may segment points associated with the second set of semantic labels into the fourth group in target point cloud 282. For example, segmentation unit 214 may segment points in target point cloud 282 associated with pedestrians, artificial objects such as traffic lights, road signs, street marks, or similar semantic labels into a “small-size” group in target point cloud 282 (e.g., denoted as C_small_tgt).

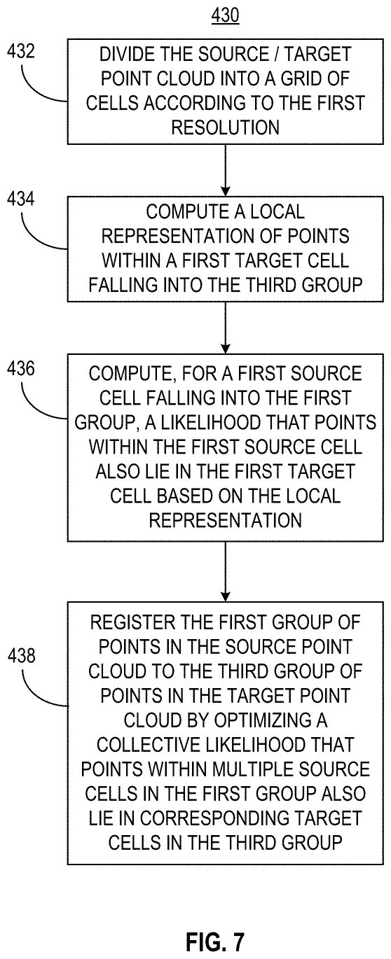

In step 430, registration unit 218 may determine an initial pose pᵢ of source point cloud 280 according to a first resolution provided by resolution selector 216. For example, registration unit 218 may determine the initial pose of source point cloud 280 by registering the first group of points in source point cloud 280 (e.g., C_large_src) to the third group of points in target point cloud 282 (e.g., C_large_tgt) according to a first resolution (e.g., r₁). FIG. 7 illustrates exemplary sub-steps of implementing step 430. Referring to FIG. 7, in step 432, registration unit 218 may divide the source/target point cloud (280/282) into a grid of cells according to the first resolution r₁. Resolution r₁ may be determined by resolution selector 216 based on semantic information parsed by semantic information parser 212, point clouds 282 and 282, and/or the segmented groups generated by segmentation unit 214. For example, resolution selector 216 may select a relatively large cell size (e.g., corresponding to a relatively low resolution) for the large-size groups (e.g., C_large_src and C_large_tgt), and a relatively small cell size (e.g., corresponding to a relatively high resolution) for the small-size groups (e.g., C_small_src and C_small_tgt). According to the selected resolution (e.g., r₁ for large-size groups), a spatial grid may be established dividing the space of source/target point cloud 280/282 into a grid of cells.

In step 434, registration unit 218 may compute a local representation of points within a first target cell falling into the third group (e.g., group C_large_tgt). In some embodiments, the local representation may include at least one of a mean or a covariance of points in the first target cell. For example, for a target cell t (in the target point cloud 282, denoted by T) that falls within group C_large_tgt, registration unit 218 may compute the mean and covariance for the points within target cell t:

$$\vec{u} = \frac{1}{m} {\sum }_{k = 1}^{m} {\vec{y}}_{k} , \\ Σ = \frac{1}{m - 1} {\sum }_{k = 1}^{m} ( {\vec{y}}_{k} - \vec{μ} ) {( {\vec{y}}_{k} - \vec{μ} )}^{T}$$

where m is the number of points in t, \vec{y}ₖ is the position/spatial vector of the kth point, \vec{μ} is the mean, and Σ is the covariance. In some embodiments, registration unit 218 may compute local representations (e.g., means and covariances) for all target cells that fall within group C_large_tgt.

In step 436, based on the mean \vec{μ} and covariance Σ, registration unit 218 may compute, for a point \vec{x} in a source cell s (in the source point cloud 280, denoted by S) that falls within group C_large_src, the likelihood that point \vec{x} also lies in target cell t:

$$p ( \vec{x} ) = \frac{1}{{( 2 π )}^{D \text{/} 2} \sqrt{\vert Σ \vert}} exp ( - \frac{{( \vec{x} - \vec{μ} )}^{T} {Σ}^{- 1} ( \vec{x} - \vec{μ} )}{2} )$$

where D is a normalization coefficient, and p(\vec{x}) is the probability function (e.g., indicating the likelihood) that point \vec{x} also lies in target cell t. The larger the value of p(\vec{x}), the more likely that point \vec{x} also lies in target cell t. In some embodiments, registration unit 218 may compute the probability functions for all points in source cell s.

In step 438, registration unit 218 may register the first group of points (e.g., points in group C_large_src) in the source point cloud 280 to the third group of points (e.g., points in group C_large_tgt) in the target point cloud 282 by optimizing a collective likelihood that points within multiple source cells in the first group C_large_src also lie in corresponding target cells in the third group C_large_tgt. For example, the collective likelihood function can be represented as:

$$Ψ = {\prod }_{k = 1}^{n} p ( T ( \vec{p} , {\vec{x}}_{k} ) )$$

wherein T(\vec{p},\vec{x}ₖ) is a spatial transformation function that moves a point \vec{x}ₖ in space by a pose \vec{p}, and n is the total number of points in group C_large_src that includes multiple source cells. The initial pose pᵢ can be computed by maximizing the collective likelihood function Ψ. Maximizing Ψ can be solved as an optimization problem using an iterative approach, in which each iteration would move the solution toward the optimal solution. After multiple iterations, or until a tolerance or threshold is reaches, the initial pose pᵢ can be obtained.

Because initial pose pᵢ is obtained using relatively low resolution r₁ and by registering points segmented into the large-size groups (C_large_src and C_large_tgt) in source and target point clouds 280 and 282, respectively, the computational cost is relatively low and the optimization iteration process is less susceptible to initial estimation errors and local optimum problem. Thus, the efficiency and speed can be improved. After the initial pose pᵢ is obtained, the initial pose can be refined by finely adjusting the initial pose to achieve higher precision and accuracy using a second, higher resolution r₂.

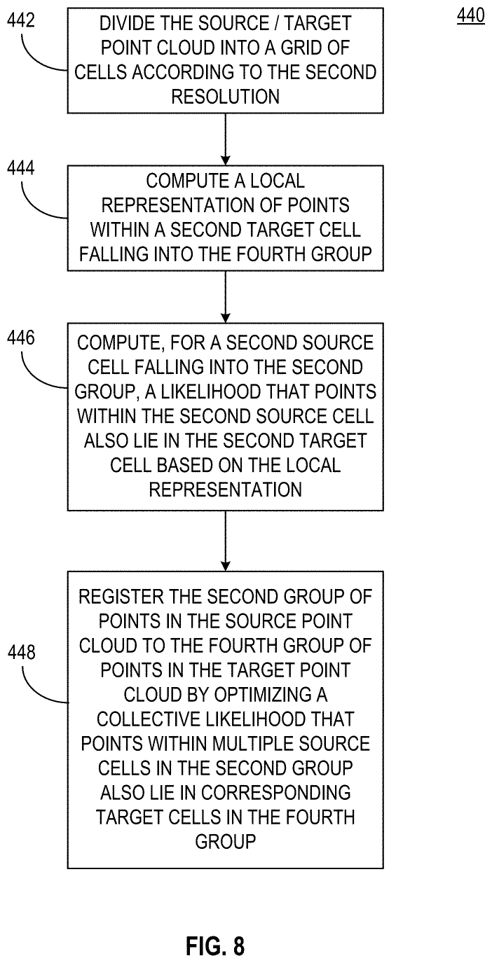

Referring back to FIG. 4, in step 440, registration unit 218 may adjust/refine the initial pose pᵢ according to the second resolution r₂ provided by resolution selector 216. For example, registration unit 218 may adjust the initial pose pᵢ of source point cloud 280 by registering the second group of points in source point cloud 280 (e.g., C_small_src) to the fourth group of points in target point cloud 282 (e.g., C_small_tgt) according to the second resolution r₂. FIG. 8 illustrates exemplary sub-steps of implementing step 440. Referring to FIG. 8, in step 442, registration unit 218 may divide the source/target point cloud (280/282) into a grid of cells according to the second resolution r₂. Resolution r₂ may be determined by resolution selector 216 based on semantic information parsed by semantic information parser 212, point clouds 282 and 282, and/or the segmented groups generated by segmentation unit 214. For example, resolution selector 216 may select a relatively small cell size (e.g., corresponding to a relatively high resolution) for the small-size groups (e.g., C_small_src and C_small_tgt) for refining the initial pose pᵢ. According to the selected resolution (e.g., r₂ for small-size groups), a spatial grid may be established dividing the space of source/target point cloud 280/282 into a grid of cells.

In step 444, registration unit 218 may compute a local representation of points within a second target cell falling into the fourth group (e.g., group C_small_tgt). In some embodiments, the local representation may include at least one of a mean or a covariance of points in the second target cell. For example, for a target cell t′ (in the target point cloud 282, denoted by T) that falls within group C_small_tgt, registration unit 218 may compute the mean and covariance for the points within target cell t′ according to equation (1) discussed above. In some embodiments, registration unit 218 may compute local representations (e.g., means and covariances) for all target cells that fall within group C_small_tgt.

In step 446, based on the mean \vec{μ} and covariance Σ, registration unit 218 may compute, for a point \vec{x} in a source cell s′ (in the source point cloud 280, denoted by S) that falls within group C_small_src, the likelihood that point x also lies in target cell t′ can be computed according to equation (2), as discussed above. In some embodiments, registration unit 218 may compute the probability functions for all points in source cell s′.

In step 448, registration unit 218 may register the second group of points (e.g., points in group C_small_src) in the source point cloud 280 to the fourth group of points (e.g., points in group C_small_tgt) in the target point cloud 282 by optimizing a collective likelihood that points within multiple source cells in the second group C_small_src also lie in corresponding target cells in the fourth group C_small_tgt. The collective likelihood function can be represented by equation (3) discussed above. The refined pose pᵣ can be computed by maximizing the collective likelihood function Ψ. Maximizing Ψ can be solved as an optimization problem using an iterative approach, in which each iteration would move the solution toward the optimal solution. After multiple iterations, or until a tolerance or threshold is reaches, the refined pose pᵣ can be obtained.

Another aspect of the disclosure is directed to a non-transitory computer-readable medium storing instructions which, when executed by at least one processor (e.g., processor 210), cause the at least one processor to perform the methods disclosed herein. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. The computer-readable medium may be a disc, a flash drive, or a solid-state drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for registering point clouds, comprising:
a memory storing computer-executable instructions; and
at least one processor communicatively coupled to the memory, wherein the computer-executable instructions, when executed by the processor, cause the processor to perform operations comprising:
parsing semantic information from a source point cloud and a target point cloud;
segmenting points in the source point cloud into first and second groups based on the semantic information parsed from the source point cloud;
segmenting points in the target point cloud into third and fourth groups based on the semantic information parsed from the target point cloud;
determining an initial pose of the source point cloud by registering the first group of points in the source point cloud to the third group of points in the target point cloud according to a first resolution; and
adjusting the initial pose of the source point cloud by registering the second group of points in the source point cloud to the fourth group of points in the target point cloud according to a second resolution, wherein the second resolution is different from the first resolution.

2. The system of claim 1, wherein parsing the semantic information comprises:
classifying, by a classifier, the points in the source and target point clouds into a plurality of categories; and
associating semantic labels with points in the categories.

3. The system of claim 2, wherein the operations further comprise:
determining semantic features associated with a training data set; and
training the classifier based on the semantic features.

4. The system of claim 2, wherein segmenting points in the source and target point clouds comprises:
segmenting points associated with a first set of semantic labels into the first group and the third group in the source and target point clouds, respectively; and
segmenting points associated with a second set of semantic labels into the second group and the fourth group in the source and target point cloud, respectively.

5. The system of claim 4, wherein:
the first set of semantic labels corresponds to objects having a first range of dimensions; and
the second set of semantic labels corresponds to objects having a second range of dimensions that are smaller than the objects having the first range of dimensions.

6. The system of claim 1, wherein determining the initial pose of the source point cloud comprises:
dividing the source and target point clouds into a grid of cells according to the first resolution, respectively;
computing, for a first target cell falling into the third group, a local representation of points within the first target cell;
computing, for a first source cell falling into the first group, a likelihood that points within the first source cell also lie in the first target cell based on the local representation; and
registering the first group of points in the source point cloud to the third group of points in the target point cloud by optimizing a collective likelihood that points within multiple source cells in the first group also lie in corresponding target cells in the third group.

7. The system of claim 6, wherein the local representation comprises at least one of a mean or a covariance of points in the first target cell.

8. The system of claim 1, wherein adjusting the initial pose of the source point cloud comprises:
dividing the source and target point clouds into a grid of cells according to the second resolution, respectively;
computing, for a second target cell falling into the fourth group, a local representation of points within the second target cell;
computing, for a second source cell falling into the second group, a likelihood that points within the second source cell also lie in the second target cell based on the local representation; and
registering the second group of points in the source point cloud to the fourth group of points in the target point cloud by optimizing a collective likelihood that points within multiple source cells in the second group also lie in corresponding target cells in the fourth group.

9. The system of claim 1, wherein the second resolution is higher than the first resolution.

10. A method for registering point clouds, comprising:
parsing semantic information from a source point cloud and a target point cloud;
segmenting points in the source point cloud into first and second groups based on the semantic information parsed from the source point cloud;
segmenting points in the target point cloud into third and fourth groups based on the semantic information parsed from the target point cloud;
determining an initial pose of the source point cloud by registering the first group of points in the source point cloud to the third group of points in the target point cloud according to a first resolution; and
adjusting the initial pose of the source point cloud by registering the second group of points in the source point cloud to the fourth group of points in the target point cloud according to a second resolution, wherein the second resolution is different from the first resolution.

11. The method of claim 10, wherein parsing the semantic information comprises:
classifying, by a classifier, the points in the source and target point clouds into a plurality of categories; and
associating semantic labels with points in the categories.

12. The method of claim 11, further comprising:
determining semantic features associated with a training data set; and
training the classifier based on the semantic features.

13. The method of claim 11, wherein segmenting points in the source and target point clouds comprises:
segmenting points associated with a first set of semantic labels into the first group and the third group in the source and target point clouds, respectively; and
segmenting points associated with a second set of semantic labels into the second group and the fourth group in the source and target point cloud, respectively.

14. The method of claim 13, wherein:
the first set of semantic labels corresponds to objects having a first range of dimensions; and
the second set of semantic labels corresponds to objects having a second range of dimensions that are smaller than the objects having the first range of dimensions.

15. The method of claim 10, wherein determining the initial pose of the source point cloud comprises:
dividing the source and target point clouds into a grid of cells according to the first resolution, respectively;
computing, for a first target cell falling into the third group, a local representation of points within the first target cell;
computing, for a first source cell falling into the first group, a likelihood that points within the first source cell also lie in the first target cell based on the local representation; and
registering the first group of points in the source point cloud to the third group of points in the target point cloud by optimizing a collective likelihood that points within multiple source cells in the first group also lie in corresponding target cells in the third group.

16. The method of claim 15, wherein the local representation comprises at least one of a mean or a covariance of points in the first target cell.

17. The method of claim 10, wherein adjusting the initial pose of the source point cloud comprises:
dividing the source and target point clouds into a grid of cells according to the second resolution, respectively;
computing, for a second target cell falling into the fourth group, a local representation of points within the second target cell;
computing, for a second source cell falling into the second group, a likelihood that points within the second source cell also lie in the second target cell based on the local representation; and
registering the second group of points in the source point cloud to the fourth group of points in the target point cloud by optimizing a collective likelihood that points within multiple source cells in the second group also lie in corresponding target cells in the fourth group.

18. The method of claim 10, wherein the second resolution is higher than the first resolution.

19. A non-transitory computer-readable medium storing instructions that, when executed by at least one processor, cause the processor to perform a method for registering point clouds, the method comprising:
parsing semantic information from a source point cloud and a target point cloud;
segmenting points in the source point cloud into first and second groups based on the semantic information parsed from the source point cloud;
segmenting points in the target point cloud into third and fourth groups based on the semantic information parsed from the target point cloud;
determining an initial pose of the source point cloud by registering the first group of points in the source point cloud to the third group of points in the target point cloud according to a first resolution; and
adjusting the initial pose of the source point cloud by registering the second group of points in the source point cloud to the fourth group of points in the target point cloud according to a second resolution, wherein the second resolution is different from the first resolution.

20. The non-transitory computer-readable medium of claim 19, wherein the second resolution is higher than the first resolution.
